(19) United States
(12) Patent Application Publication
(10) Pub. No.: US 2014/0227145 A1
(43) Pub. Date: Aug. 14, 2014

(54) FLUID DISCHARGING DEVICE AND METHOD

(71) Applicants: Sang Jin Kim, Suwon-Si (KR); Suk-ho Song, Asan-Si (KR); Bo Sung Ku, Suwon-Si (KR); Moo-Yeal Lee, Burlingame, CA (US)

(72) Inventors: Sang Jin Kim, Suwon-Si (KR); Suk-ho Song, Asan-Si (KR); Bo Sung Ku, Suwon-Si (KR); Moo-Yeal Lee, Burlingame, CA (US)

(73) Assignees: SAMSUNG ELECTRO-MECHANICS, INC., Suwon,Gyunggi-Do (KR); SOLIDUS BIOSCIENCES, INC., San Francisco, CA (US)

(21) Appl. No.: 13/821,928

(22) PCT Filed: May 17, 2012
(86) PCT No.: PCT/US12/38273

§ 371 Date: May 20, 2013

Related U.S. Application Data
(60) Provisional application No. 61/487,102, filed on May 17, 2011.

(51) Int. Cl. B01L 3/02

(52) U.S. Cl. CPC B01L 3/0293
USPC 422/500

(57) ABSTRACT

There is provided a fluid discharging device including: a first pressure generating unit generating a first pressure for discharging a fluid; a second pressure generating unit generating a second pressure for discharging a fluid, and being controllable so as to change a magnitude of the second pressure; and a nozzle discharging the fluid pressurized by the first and second pressure generating units.

### RELATED APPLICATION

This application claims the benefit of U.S. Provisional Application No. 61/487,102, filed on May 17, 2011. The entire teaching of the above application is incorporated herein by reference

### BACKGROUND OF THE INVENTION

1. Field of the Invention

The present invention relates to a fluid discharging device and method for discharging a predetermined amount of fluid, and more particularly, to a fluid discharging device and method selectively discharging a relatively small amount of fluid and a relatively large amount of fluid in terms of flow amount and finely discharging fluid having a wide range in terms of viscosity.

2. Description of the Related Art

In performing research using a biochip, quantitatively supplying a culture solution or a reagent to the biochip is a very important factor in determining the accuracy of experimental results.

A problem of quantitatively supplying liquid is more important in a cell chip in which a toxicity test, an anti-cancer sensitiveness test and a resistance test are necessarily required in order to develop a new medicine.

According to the related art, a liquid discharging device including a ceramic nozzle connected to a pump unit through a tube has been used in supplying liquid to the biochip. Even in the case that the amount of a discharged liquid is controlled through an electronic control, the fluid discharging device has supplied a droplet having a minimal amount of liquid (several tens of microliters) through the ceramic nozzle, thereby having a difficulty in supplying a quantitative amount and a fine amount of liquid.

In order to solve this problem, an electronic pipette capable of supplying a droplet having an amount of liquid several nls or less through electronic control has been developed. However, the electronic pipette has a significant difficulty in supplying a large amount of liquid in a droplet and discharging a high viscosity material.

Therefore, according to the related art, a fluid discharging device for discharging a large amount of fluid and a fluid discharging device for discharging a small amount of fluid according to the quantity of discharged of fluid should be provided or a fluid discharging device for high viscosity liquid and a fluid discharging device for low viscosity liquid according to the viscosity of discharged liquid should be provided, such that the use thereof is inconvenient and a high cost is incurred.

In addition, since the fluid discharging device and the electronic pipette for discharging the small amount of liquid should be alternately used according to the discharged amounts and viscosities of liquid, the time required to replace or operate the experimental devices has been increased and the accuracy of experiments has been deteriorated due to a reduction in concentration of an experimenter.

### SUMMARY OF THE INVENTION

An aspect of the present invention provides a fluid discharging device and method capable of selectively discharging a relatively small amount of fluid and a relatively large amount of fluid in a wide range of viscosities from low viscosity to high viscosity.

According to an aspect of the present invention, there is provided a fluid discharging device including: a first pressure generating unit generating a first pressure for discharging a fluid; a second pressure generating unit generating a second pressure for discharging a fluid, and being controllable so as to change a magnitude of the second pressure; and a nozzle discharging the fluid pressurized by the first and second pressure generating units.

The first and second pressure generating units may be connected in series with the nozzle.

The first and second pressure generating units may be connected in parallel with the nozzle.

The nozzle may have a storage space storing the fluid therein.

The first pressure generating unit may be installed in the storage space.

According to another aspect of the present invention, there is provided a fluid discharging method comprising discharging a relatively small amount of fluid and a relatively large amount of fluid by generating pressures having different magnitudes.

The discharging of the relatively small amount of fluid and the relatively large amount of fluid may include discharging different amounts of fluids by simultaneously or selectively generating the pressures having the different magnitudes.

The discharging of the relatively small amount of fluid and the relatively large amount of fluid may include discharging different amounts of fluids by adding or subtracting the pressures having the different magnitudes.

The discharging of the relatively small amount of fluid and the relatively large amount of fluid may include quantitatively discharging fluids having different viscosities by simultaneously or selectively generating the pressures having the different magnitudes.

The discharging of the relatively small amount of fluid and the relatively large amount of fluid may include quantitatively discharging fluids having different viscosities by adding or subtracting the pressures having the different magnitudes.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view showing the configuration of a fluid discharging device according to a first embodiment of the present invention;

FIG. 2 is a view showing the configuration of a fluid discharging device according to a second embodiment of the present invention; and

FIG. 3 is a view showing the configuration of a fluid discharging device according to a third embodiment of the present invention.

### DETAILED DESCRIPTION OF THE PREFERRED EMBODIMENT

Exemplary embodiments of the present invention will be described in detail with reference to the accompanying drawings.

In describing the present invention below, terms indicating components of the present invention are used in consideration of functions of each of the components. Therefore, these terms should not be interpreted as limiting the technical components of the present invention.

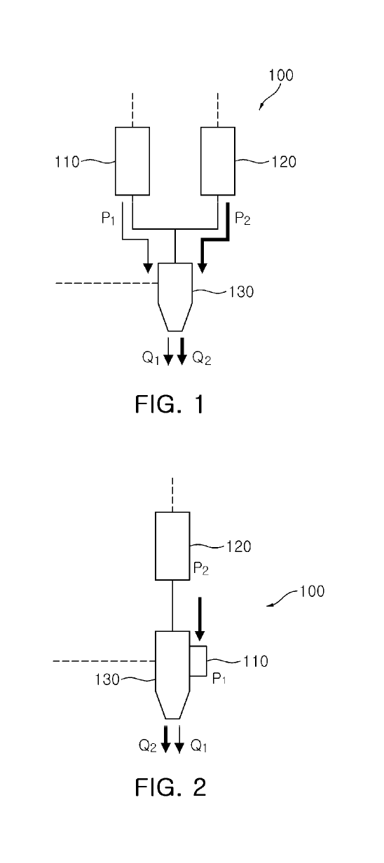

A fluid discharging device according to a first embodiment of the present invention will be described with reference to FIG. 1. FIG. 1 is a view showing the configuration of a fluid discharging device according to the first embodiment of the present invention.

A fluid discharging device 100 according to the first embodiment of the present invention includes a first pressure generating unit 110, a second pressure generating unit 120, and a nozzle 130.

The first pressure generating unit 110 is connected to the nozzle 130, and generates a first pressure P1 having a predetermined magnitude. The first pressure P1 generated from the first pressure generating unit 110 is transferred to the nozzle 130. Therefore, when the first pressure generating unit 110 is operated, a first flow amount Q1 of fluid corresponding to the first pressure P1 may be discharged.

The first pressure generating unit 110 may store a predetermined amount of fluid therein. In this case, when the first pressure generating unit 110 generates the first pressure P1, the flow amount of fluid corresponding to the first pressure P1 is supplied to the nozzle 130. The fluid supplied to the nozzle 130 may be discharged through the nozzle 130 simultaneously with the operation of the first pressure generating unit 110. Meanwhile, in the case in which a continuous supply of the fluid is required, the first pressure generating unit 110 may be directly connected to a fluid supply source.

The first pressure generating unit 110 is formed as a pressure generating device generating a predetermined pressure. The first pressure generating unit 110 may be formed to have a piezoelectric element pressurizing the fluid in a vibrating method, a heating element generating pressure through air bubbles generated during the heating of the fluid, and the like.

The second pressure generating unit 120 is connected to the nozzle 130, and generates a second pressure P2 having a predetermined magnitude. Here, the second pressure P2 may be larger than the first pressure P1. The second pressure P1 generated from the second pressure generating unit 120 is transferred to the nozzle 130. Therefore, when the second pressure generating unit 120 is operated, a second flow amount Q2 of fluid may be discharged through the nozzle 130. The flow amount discharged through the nozzle may be proportional to the second pressure P2. For reference, the magnitude of the second pressure P2 may be proportional to that of the first pressure P1; however, it may be determined to be any magnitude if needed.

The second pressure generating unit 120 may store a predetermined amount of fluid therein. In this case, when the second pressure generating unit 120 generates the second pressure P2, the flow amount of fluid corresponding to the second pressure P2 is supplied to the nozzle 130. The fluid supplied to the nozzle 130 may be discharged through the nozzle 130 simultaneously with the operation of the second pressure generating unit 120. Meanwhile, in the case in which a continuous supply of the fluid is required, the second pressure generating unit 120 may be directly connected to a fluid supply source.

The second pressure generating unit 120 is formed as a pressure generating device generating a predetermined pressure. The second pressure generating unit 120 may be formed to have a piezoelectric element pressurizing the fluid in a vibrating method, a heating element generating pressure through air bubbles generated during the heating of the fluid, and the like. The second pressure generating unit 120 may be preferably formed to have a piezoelectric element having larger capacity than that of the piezoelectric element of the first pressure generating unit 110, a plurality of piezoelectric elements, or a small pump. In the case in which the second pressure generating unit 120 has the plurality of piezoelectric elements, the magnitude of pressure for discharging the fluid may be controlled in a wide range.

The nozzle 130 is connected to the first and second pressure generating units 110 and 120. When the pressure is generated from the first pressure generating unit 110 or the second pressure generating unit 120, the nozzle 130 discharges the flow amount of fluid corresponding to the pressure.

The nozzle 130 may include a storage space storing the fluid therein. In this case, the storage space may have a sufficient large volume so that all flow amounts corresponding to the pressure generated from the first and second pressure generating units 110 and 120 may be stored therein. For example, the storage space may be manufactured to have a size allowing for the storage of the flow amount corresponding to the pressure (P1+P2) generated by the first and second pressure generating units 110 and 120. The nozzle may be directly connected to a fluid supply source supplying the fluid.

For reference, although not shown in FIGS. 1 and 2, at least one of the pressure generating units 110 and 120 and the nozzle 130 may be connected to a separate pump device so as to intake fluid through the nozzle 130. Alternatively, the pressure generating units 110 and 120 may generate a negative pressure so as to intake fluid through the nozzle 130.

Meanwhile, the flow amount discharged through a single operation of the pressure generating units 110 and 120 may be changed according to the viscosity or specific gravity of fluid. For example, a greater amount of a fluid having a relatively small viscosity or specific gravity may be discharged through a single operation of the pressure generating units 110 and 120 than that of a fluid having a relatively large viscosity or specific gravity.

The change in the discharged flow amount according to the viscosity or specific gravity of the fluid may hinder an accurate experimental value from being obtained in an experiment treating various samples.

In addition, as described in a background section of the present invention, cases in which a small amount of fluid and a large amount of fluid are discharged in the experiment treating various samples coexist. For example, an experimental object material or an additive (or an active material) tends to be discharged in a small amount, while a fixative fixing the experimental object material or other solution tends to be discharged in a large amount.

However, since a pipette generally used in a laboratory does not separately discharge a large amount of material and a small amount of material, a pipette for discharging a large amount of material and a pipette for discharging a small amount of material should be provided, respectively.

The present embodiment is intended to solve these problems. Hereinafter, a fluid discharging method of the fluid discharging device 100 for solving the problems will be described.

The fluid discharging device 100 according to the present embodiment includes at least two pressure generating units 110 and 120 providing pressures having different magnitudes, whereby the above-mentioned problems according to the related art may be solved.

1) Case in which different kinds of fluids having different viscosities or specific gravities are quantitatively discharged.

Generally, a fluid having a relatively low viscosity (or specific gravity) (hereinafter, referred to as a “general fluid”) is relatively thin, such that it is easily discharged. However, a fluid having a relatively high viscosity (or specific gravity) (hereinafter, referred to as a “viscous fluid”) is relatively thick, such that it may be difficult to discharge. For reference, in the present embodiment, viscous fluid refers to a fluid having a viscosity exceeding 20 cP and general fluid refers to a fluid having a viscosity of 20 cP or less.

In consideration of this, the general fluid and the viscous fluid are discharged by the following method.

(General Fluid)

In the case in which general fluid is discharged, only the first pressure generating unit 110 may be used.

General fluid is relatively thin as described above, such that a predetermined amount of fluid corresponding to the first pressure P1 of the first pressure generating unit 110 may be discharged. For example, the first pressure generating unit 110 may allow 1 of of general fluid to be discharged through a single operation thereof. In the case in which 3 nl of general fluid attempt to be discharged, the first pressure generating unit 110 has to be operated three times.

In this case, the second pressure generating unit 120 is maintained in an atmospheric pressure state or is not operated.

(Viscous Fluid)

In the case in which viscous fluid is discharged, both of the first pressure generating unit 110 and the second pressure generating unit 120 may be used.

Viscous fluid is relatively thick as described above, such that it may be difficult to quantitatively discharge by only using the first pressure P1 of the first pressure generating unit 110.

For example, if 1 nl of general fluid is discharged through a single operation of the first pressure generating unit 110, less than 1 nl of viscous fluid is discharged through a single operation of the first pressure generating unit 110. Therefore, the pressure of the first pressure generating unit 110 should be compensated for in order to discharge viscous fluid and general fluid in the same amount.

In the present embodiment, the second pressure generating unit 120 performs this function. That is, the second pressure generating unit 120 generates pressure required for discharging a quantitative amount of viscous fluid, together with the first pressure generating unit 110.

For example, when the first pressure generating unit 110 lacks a pressure of 0.1 Pa to discharge 1 of of viscous fluid having a viscosity of 30 cP, the second pressure generating unit 120 generates a pressure of 0.1 Pa. Here, the second pressure generating unit 120 may be formed to have a plurality of piezoelectric elements to thereby control the pressure generated therein.

Meanwhile, since the viscosity [Pa·s: CGS unit, 1000 cP] may be represented by a function in proportion to the pressure [Pa]. Therefore, when the viscosity of viscous fluid is known, the compensation pressure of the second pressure generating unit 120 may be calculated.

Therefore, according to the present embodiment, different kinds of fluids having different viscosities may be quantitatively discharged.

2) Case in which a large amount of fluid and a small amount of fluid are required to be discharged.

In the present case, a large amount of fluid and a small amount of fluid may be discharged by two methods.

A first method is to separately control the first pressure generating unit 110 and the second pressure generating unit 120.

That is, in the case in which a small amount of fluid is required to be discharged, a first flow amount Q1 of fluid is discharged using the first pressure generating unit 110, and in the case in which a large amount of fluid is required to be discharged, a second flow amount Q2 of fluid is discharged using the second pressure generating unit 120.

Here, since the second pressure P2 of the second pressure generating unit 120 may be set to be larger than the first pressure P1 of the first pressure generating unit 110, the second pressure generating unit 120 may allow a large amount of fluid to be discharged. The second pressure P2 of the second pressure generating unit 120 may be set to be appropriate for the discharging of the large amount of fluid.

The present method may change the magnitude of pressures of the first and second pressure generating units 110 and 120 to thereby change the discharging amount corresponding to the small amount and the discharging amount corresponding to the large amount.

A second method is to control the first pressure generating unit 110 and the second pressure generating unit 120 in combination.

That is, in the case in which a small amount of fluid is required to be discharged, the first flow amount Q1 or the second flow amount Q2 of fluid is discharged using the first or second pressure generating unit 110 or 120, and in the case in which a large amount of fluid is required to be discharged, a third flow amount Q1+Q2 of fluid is discharged using both of the first and second pressure generating units 110 and 120.

In the case in which the small amount of fluid is discharged, only the flow amount Q1 or Q2 corresponding to the pressure generated from any one of the first and second pressure generating units 110 and 120 is discharged, and in the case in which the large amount of fluid is discharged, the flow amount Q1+Q2 corresponding to the pressure generated from both of the first and second pressure generating units 110 and 120 is discharged.

According to the present method, three different flow amounts may be discharged: the discharging of the first flow amount Q1 by the first pressure generating unit 110, the discharging of the second flow amount Q2 by the second pressure generating unit 120, and the discharging of the third flow amount Q1+Q2 by the first pressure generating unit 110 and the second pressure generating unit 120. Therefore, according to the present method, the discharging amount may be finely controlled.

A fluid discharging device according to a second embodiment of the present invention will be described with reference to FIG. 2. FIG. 2 is a view showing the configuration of a fluid discharging device according to the second exemplary embodiment of the present invention. The second embodiment is different from the first embodiment in the arrangement of the pressure generating units 110 and 120. For reference, in the second embodiment, the same reference numerals will be used to designate the same components as those described in the first embodiment. A detailed description thereof will be omitted.

In the present embodiment, the first pressure generating unit 110 is mounted on the nozzle 130. That is, in the fluid discharging device 100 according to the second embodiment, the first pressure generating unit 110 and the second pressure generating unit 120 are connected in series.

This may significantly facilitate the slimness of the fluid discharging device 100.

In the case in which the first pressure generating unit 110 is formed as a piezoelectric element, it may be easily installed in the inside of the nozzle 130. Likewise, in the case in which the second pressure generating unit 120 is formed as a piezoelectric element or a small pump, it may also be directly installed in the nozzle 130.

The fluid discharging device 100 configured as described above perform the discharging of a small amount of fluid and a large amount of fluid by the same method as that of the first embodiment. The small amount of fluid may be discharged by using the first pressure generating unit 110, and the large amount of fluid may be discharged by using the second pressure generating unit 120.

Meanwhile, in the present embodiment, the first and second pressure generating units 110 and 120 are connected to each other in series, such that the sum of pressures of the first and second pressure generating units 110 and 120 may be easily generated. Therefore, the present embodiment is very effective in discharging the large amount of fluid using the first and second pressure generating units 110 and 120.

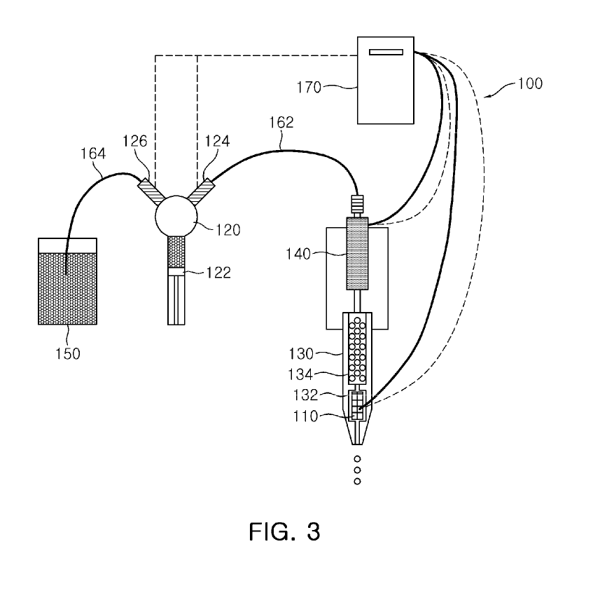

Hereinafter, a fluid discharging device according to a third embodiment of the present invention will be described with reference to FIG. 3. The third embodiment has a form in which the features of the second embodiment are more specifically implemented. For reference, in the third embodiment, the same reference numerals will be used to designate the same components as those described in the second embodiment. A detailed description thereof will be omitted.

The fluid discharging device 100 according to the third embodiment of the present invention includes the first pressure generating unit 110, the second pressure generating unit 120, the nozzle 130, an electronic valve 140, a storage tank 150, and a control device 170.

The first pressure generating unit 100 is formed as a small piezoelectric element. Therefore, the first pressure generating unit 100 may be installed in the nozzle 130. For reference, in the present embodiment, the first pressure generating unit 110 is installed in a first space 132 formed in the inside of the nozzle 130. The first pressure generating unit 110 installed in the first space 132 applies pressure to fluid stored in the first space 132 to allow the fluid to be discharged through the nozzle 130. Here, the first space 132 is a small space allowing for the storage of several nls of fluid therein, and the first pressure generating unit 110 generates the pressure required for discharging several nls (preferably, 1 nl or less) of fluid.

The second pressure generating unit 120 is formed as a small pump. For example, the second pressure generating unit 120 may be a syringe pump generating a positive pressure and a negative pressure (or a vacuum pressure) by the reciprocating movement of a piston 122. The second pressure generating unit 120 generates the pressure required for discharging several tens of nls (preferably, 20 nls) of fluid. The second pressure generating unit 120 is connected to the nozzle 130 or the first pressure generating unit 110 via a first tube 162.

The second pressure generating unit 120 includes a first valve 124 and a second valve 126.

The first valve 124 is installed to be connected to the first tube 162. The first valve 124 controls pressure and the movement of fluid between the nozzle 130 and the second pressure generating unit 120.

For example, when it is necessary to supply the fluid from the second pressure generating unit 120 to the nozzle 130 or to apply pressure thereto, the first valve 124 is opened so that the fluid stored in the second pressure generating unit 120 and the pressure of the second pressure generating unit 120 may be transferred to the nozzle 130. However, when the fluid is supplied from the storage tank 150 to the second pressure generating unit 120 (when the second pressure generating unit 120 generates a negative pressure), the first valve 124 is closed so that the fluid stored in the nozzle 130 does not move to the second pressure generating unit 120.

The second valve 126 is installed to be connected to a second tube 164. The second valve 126 controls pressure and the movement of fluid between the second pressure generating unit 120 and the storage tank 150.

For example, when the fluid is supplied from the storage tank 150 to the second pressure generating unit 120 (when the second pressure generating unit 120 generates a negative pressure), the second valve 126 is opened so that the fluid stored in the storage tank 150 may move to the second pressure generating unit 120. However, when it is necessary to supply the fluid from the second pressure generating unit 120 to the nozzle 130 or to apply pressure thereto, the second valve 126 is closed so that the fluid stored in the second pressure generating unit 120 and the pressure of the second pressure generating unit 120 is not transferred to the storage tank 150.

For reference, the first and second valves 124 and 126 may be controlled according to a control signal of the control device 170.

The nozzle 130 discharges the fluid according to the pressure generated from the pressure generating units 110 and 120. The nozzle 130 includes the first space 132 and a second space 134. The fluid to be discharged is stored in the respective spaces 132 and 134. Here, a volume of the first space 132 may be the same as that of the first flow amount Q1 to be discharged by the operation of the first pressure generating unit 110, and a volume of the second space 134 may be the same as that of the second flow amount Q2 to be discharged by the operation of the second pressure generating unit 120.

The electronic valve 140 is installed in the nozzle 130 or the first tube 162. The electronic valve 140 is connected to the control device 170, such that the degree of opening and closing thereof is controlled by the control signal of the control device 170. The electronic valve 140 is used to finely control the flow amount of fluid supplied from the second pressure generating unit 120. Therefore, the electronic valve 140 may be omitted in some cases.

The storage tank 150 stores the fluid to be discharged or a cleaning solution therein. The storage tank 150 is connected to the second pressure generating unit 120 to supply the fluid or the cleaning solution thereto. For reference, in the case in which the intake of fluid may be directly performed through the nozzle 130, the storage tank 150 may be omitted.

The control device 170 controls the operations of the pressure generating units 110 and 120 and the valves 124, 126, and 140. The control device 170 controls the operating states of the above-mentioned components so that a small amount of fluid or a large amount of fluid may be discharged according to a user's selection.

For example, the control device 170 operates only the first pressure generating unit 110 in the case in which the small amount of fluid is required to be discharged, and operates only the second pressure generating unit 120 in the case in which the large amount of fluid is required to be discharged.

An operating sequence of the fluid discharging device 100 according to the discharging of the small amount of fluid and the discharging of the large amount of fluid is as follows:

First, the following preparing operation is performed for fluid discharging.

1) Filling the inside of the second pressure generating unit 120 with a fluid

In a state in which the first value 124 is closed and the second value 126 is opened, a negative pressure is generated in the inside of the second pressure generating unit 120. At this time, the fluid in the storage tank 150 moves to the second pressure generating unit 120 to fill the inside of the second pressure generating unit 120.

2) Filling the inside of the nozzle 130 with the fluid

In a state in which the second value 126 is closed and the first value 124 and the electronic valve 140 are opened, a positive pressure is generated in the second pressure generating unit 120. At this time, the fluid stored in the second pressure generating unit 120 fills the spaces 132 and 134 of the nozzle 130.

When the preparation for fluid discharging is finished through the above-mentioned process, the discharging of the small amount of fluid and the discharging of the large amount of fluid are performed according to the user's selection. The discharging of the small amount of fluid and the large amount of fluid may be performed as follows:

1) Discharging of the small amount of fluid

The small amount of fluid is discharged through the operation of the first pressure generating unit 110. When the user selects the discharging of the small amount of fluid, the control device 170 operates the first pressure generating unit 110. In this case, the first pressure P1 is generated in the inside of the first space 132, and the fluid stored in the first space 132 is discharged to the outside of the nozzle 130. Here, the discharging amount of the fluid is defined as a volume of the first space 132.

2) Discharging of the large amount of fluid

The large amount of fluid is discharged through the operation of the second pressure generating unit 120. When the user selects the discharging of the large amount of fluid, the control device 170 operates the second pressure generating unit 120, and opens the first valve 124 and the electronic valve 140. In this case, the fluid stored in the first space 132 and the second space 134 is discharged to the outside of the nozzle 130 by the second pressure P2 generated from the second pressure generating unit 120. Here, the discharging amount of the fluid is defined as an amount corresponding to one stroke of the piston 122.

As set forth above, according to exemplary embodiments of the present invention, a plurality of pressure generating units are selectively operated, whereby a relatively small amount of fluid and a relatively large amount of fluid may be discharged according to a user's convenience.

Therefore, there is no need to include a plurality of fluid discharging devices for discharging different amounts of fluid.

In addition, according to exemplary embodiments of the present invention, a magnitude of pressure for discharging fluid may be arbitrarily changed, such that fluids having different viscosities, particularly, bio materials having a high viscosity may also be quantitatively discharged.

Therefore, a biochemical experiment treating materials having various viscosities may be performed precisely and accurately.

While the present invention has been shown and described in connection with the exemplary embodiments, it will be apparent to those skilled in the art that modifications and variations can be made without departing from the spirit and scope of the invention as defined by the appended claims.

What is claimed is:

1. A fluid discharging device comprising:
a first pressure generating unit generating a first pressure for discharging a fluid;
a second pressure generating unit generating a second pressure for discharging a fluid, and being controllable so as to change a magnitude of the second pressure; and
a nozzle discharging the fluid pressurized by the first and second pressure generating units.

2. The fluid discharging device of claim 1, wherein the first and second pressure generating units are connected in series with the nozzle.

3. The fluid discharging device of claim 1, wherein the first and second pressure generating units are connected in parallel with the nozzle.

4. The fluid discharging device of claim 1, wherein the nozzle has a storage space storing the fluid therein.

5. The fluid discharging device of claim 4, wherein the first pressure generating unit is installed in the storage space.

6. The fluid discharging device of claim 1, wherein said first pressure generating unit generating a first pressure for discharging a first flow amount, Q₁, between 0.1 and 10000 nl; preferably between 0.15 and 1000 nl; preferably between 1 and 100 nl.

7. The fluid discharging device of claim 1, wherein said second pressure generating unit generating a second pressure for discharging a second flow amount, Q₂, between 0.1 and 10000 nl; preferably between 0.15 and 1000 nl; preferably between 1 and 100 nl.

8. The fluid discharging device of claim 1, wherein said first pressure generating unit generating a first pressure for discharging a fluid discharges a first fluid and said second pressure generating unit generating a second pressure for discharging a fluid discharges a second fluid wherein said second fluid has a higher viscosity than said first fluid at 23° C. and atmospheric pressure.

9. The fluid discharging device of claim 1, wherein said first pressure generating unit comprises a first piezoelectric element.

10. The fluid discharging device of claim 1, wherein said second pressure generating unit comprises a second piezoelectric element.

11. The fluid discharging device of claim 9, wherein said first piezoelectric element is a piezoelectric disc.

12. The fluid discharging device of claim 10, wherein said second piezoelectric element is a piezoelectric disc.

13. The fluid discharging device of claim 8, wherein said first fluid comprises a protein, DNA or RNA and combinations thereof.

14. The fluid discharging device of claim 8, wherein said second fluid comprises a culture solution.

15. A fluid discharging method comprising discharging a relatively small amount of fluid and a relatively large amount of fluid by generating pressures having different magnitudes.

16. The fluid discharging method of claim 15, wherein the discharging of the relatively small amount of fluid and the relatively large amount of fluid includes discharging different amounts of fluids by simultaneously or selectively generating the pressures having the different magnitudes.

17. The fluid discharging method of claim 15, wherein the discharging of the relatively small amount of fluid and the relatively large amount of fluid includes discharging different amounts of fluids by adding or subtracting the pressures having the different magnitudes.

18. The fluid discharging method of claim 15, wherein the discharging of the relatively small amount of fluid and the relatively large amount of fluid includes quantitatively discharging fluids having different viscosities by simultaneously or selectively generating the pressures having the different magnitudes.

19. The fluid discharging method of claim 15, wherein the discharging of the relatively small amount of fluid and the relatively large amount of fluid includes quantitatively discharging fluids having different viscosities by adding or subtracting the pressures having the different magnitudes.
